(19) United States
(12) Patent Application Publication
(10) Pub. No.: US 2008/0015881 A1
(43) Pub. Date: Jan. 17, 2008

(54) PORTABLE COMMUNICATION DEVICE

(76) Inventor: Pradip Shankar, Fremont, CA (US)

Correspondence Address: West & Associates, A PC, Suite 209, 2815 Mitchell Drive, Walnut Creek, CA, 94598, US

(21) Appl. No.: 11/769,637

(22) Filed: Jun. 27, 2007

Related U.S. Application Data
(60) Provisional application No. 60/817,315, filed on Jun. 28, 2006.

(51) Int. Cl. G06Q 99/00; H04M 1/00

(52) U.S. Cl. 705/1; 455/556.1

(57) ABSTRACT

A novel system for remotely providing technical support services. The system utilizes a handheld device to provide bi-directional communications to a centralized center. Video or still images are used to convey the information to the remote support center for diagnosis, and instructions on how to fix the problem is relayed via text, video and/or voice to the remote user.

### CROSS-REFERENCE TO RELATED APPLICATIONS

This application claims the benefit of provisional patent application Ser. No. 60/817,315, filed Jun. 28, 2006.

### BACKGROUND

1. Field of the Invention

The current disclosure relates to remote help-desk applications, in particular provision of technical support with the aid of audio, video and data feeds to/from a remote location.

2. Background

The information technology and consumer electronics revolution in recent years shows no sign of slowing down. The average consumer today can be overwhelmed by the variety of high technology devices. Most capabilities and features of these new devices are just not utilized. Personal computing hardware and software is still prone to usability and functionality issues in-spite of the best efforts of developers, and there are ever-evolving ways for accessing digital media on a variety of digital devices. Add to this an aging population, and increasing reliance on technology for everyday living, it appears that technical support for the average consumer is an increasingly difficult challenge. Manufacturers of information technology and consumer electronics frequently are not equipped to assist the end-user unless there is an actual malfunction of the device, and they will not be able to assist the end-user in integrating devices from different manufacturers.

Getting immediate technical assistance from knowledgeable technical support staff is part of the solution to this problem and can alleviate a lot of the frustration experienced by end-users. For example, the “Geek Squad”, a technical assistance service offered by electronics retail chain Best Buy, L.P. can offer technical assistance on a wide range of personal computing and home electronics equipment from different manufacturers. However, their services can be expensive because it typically requires on-site service by an experienced technical staff. On the side of the technical support provider, providing a service that can cover most geographical locations requires a huge investment, because they need to staff technical experts in geographically diverse areas in order to provide coverage to all locations. Such a huge investment may be hard to justify as the return on investment is dependant on the number of service calls they receive.

Basic technology has progressed to the point where getting high quality remote assistance now makes commercial sense. Thus, what is desired is a device and service mechanism that allows for remote assistance to be made available to an end-user conveniently and at lower expense.

### SUMMARY OF THE INVENTION

In order to provide technical support services remotely, a system comprised of a portable camera and display enabled device coupled to a base-station is described. It is designed to be easy to use and has the capability for secure identification and immediate service by remote personnel. In its basic form, the device can be used to connect a consumer to a service provider over the Internet and provide voice and video communication. Other variations include different communication mechanisms, single or multiple services capable, ability to display downloaded or instructions loaded from memory, ability to recognize UPC or other codes, ability to incorporate an RFID reader, and biometric or other authentication capability. In some embodiments the system and method can be run over any device, such as a mobile telephone and/or other portable electronic device.

### BRIEF DESCRIPTION OF THE DRAWINGS

FIG. 1 depicts a front view of one embodiment of the portable technical support communication device.

FIG. 2 depicts one embodiment of a block diagram showing the network connection of the portable technical support communication device and a remote service provider.

FIG. 3 depicts an embodiment of a computer network system on which the process depicted and described in relation to FIGS. 1 and 2 can be carried out.

### DETAILED DESCRIPTION

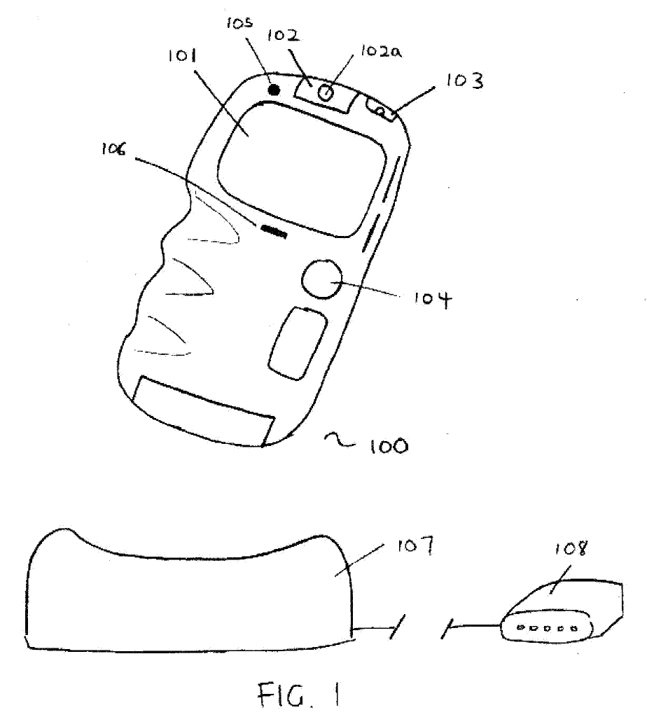

A novel handheld communication device for provision of remote video communication via a network is disclosed. An application for such a device is for providing remote technical assistance and support from a central location to remote end-users. In the embodiment depicted in FIG. 1, the device can be a small hand-held unit 100 that has a flat-panel screen 101 to display images, a camera 102 to capture video, an LED light source 103 for illumination, a single button 104 to activate the device and summon assistance, at least one speaker 105 and high sensitivity microphone pickup 106 for bi-directional voice communication, a method of wireless connection to a base-station 107 that is connected via a broadband connection to a router with optional back-up connection via phone lines. In some embodiments of the system, the handheld unit 100 is powered by rechargeable batteries that can be recharged when the handheld unit is stored in the base-station 107. The design depicted in FIG. 1 is for illustrative purposes only and is not meant to be limiting.

At the remote end, the device specific identification enables immediate user identification. With the user identified, it will be simple to pull up records of the end-user's equipment configuration for quick provision of service. The service can be comprised of two-way multimedia communication with voice and video and optionally text. In addition a control channel enables optional configuration, control and necessary updates of the device.

In further embodiments, the handheld unit can optionally include one or more of each the follow capabilities or features: Wireless connectivity to a base station via a private secure network; screen provides feedback on video being transmitted; headphone jack; flash memory slot; USB connection for download of information; a built in tripod for easy placement anywhere; a charging base for charging of rechargeable power supply; self-configuration on the private network; Roll-over to the phone network if the router does not respond; auto-dial out and connection set up; time-out mechanism or programming to ensure that the device and base-station continue to operate even if analog or dial-up connection is down; remote server captures video frames selectively—has two windows—one live, and the other for captured frames.

### Operation

A typical scenario for the use of the device is as follows: The consumer end-user needs help with his or her computer or hi-tech consumer product and needs to talk with a remote assistant. The end-user presses the “call” button 104 on the hand-held unit 100 and the device connects to the Internet wirelessly via a router or gateway 108. Once connected to the support service provider via Internet, the end-user's information or personal ID is uploaded and verified. Any method of identity/account verification known or convenient can be used, including password input, biometric scanners such as a fingerprint reader, or a credit card reader. In alternate embodiments of the device, the device can transmit a unit specific identification that is received by the remote technical support service provider that immediately enables the service provider to identify the unit and the end-user/account it belongs to. Once the user's account information is verified by the technical service provider, the account's information can be retrieved from a database. The information can include the end-user's equipment and/or hardware and software configuration, so that that information does not have to be re-captured from scratch every time the user calls for assistance.

The handheld device communicates with a base station or a router, gateway or switch wirelessly. Any wireless protocol known or convenient, including Wireless B, Wireless G, Pre-N, N, and Bluetooth® can be used. If for any reason, the router is down or an Internet connection cannot be made, a connection can be established over a dial-up connection using a regular phone line. A microphone and speaker can provide for voice communications.

In some embodiments the handheld device can communicate directly with the item of interest via a physical and/or wireless connection. In some embodiments the handheld device can acquire diagnostic data directly from the item of interest and relay the information directly to the remote service provider. In some embodiments, such diagnostic information can be obtained prior to making contact with the remote service provider. In alternate embodiments the remote service provider can trigger the remote device to obtain and/or transmit the diagnostic information and/or the remote service provider can instruct a user as to how to obtain and/or transmit the diagnostic information.

The camera on the handheld device and optional LED illumination are turned on and the device can be pointed at any item of interest. The person providing remote assistance can then view and help the consumer via two-way communication. In some embodiments, the camera can be swiveled so that it can point towards the view screen for two-way voice communication face-to-face, and point away from the view screen to capture areas of interest while the end-user views what is being captured on the screen.

In some embodiments, bandwidth use can be dramatically reduced by providing the remote service provider the option to return single and/or multiple static images to a user, rather than dynamic images and/or video. Thus, in some embodiments, a user can transmit video to the remote service provider and the remote service provider can select one or more individual frames from the video and if desired mark-up the selected frame(s) and return only the selected frame(s) to the user with instructions (textual, video and/or audio). Moreover due to the diagnostic nature of video, in some embodiments the video feed to the remote service provider can be transmitted in a reduced quality image and/or at a reduced frame-per-second speed, thus reducing bandwidth requirements.

### Video Capture

Camera functionality can be provided with a lens and sensor and/or any other known and/or convenient mechanism. The lens 102a can be fixed-focus designed to focus on objects that are close to the user and/or utilize any known and/or convenient mechanism to adjust focal length. In some embodiments, the focal length range can be between 6″ to 3′ and/or any known and/or convenient distance. In some embodiments, the device can be capable of capturing diagnostic quality images under low light conditions or light conditions where there can be an LED illumination source operational. The sensor converts light input from the lens into electrical output. The electrical output is digitized using an analog to digital converter that is often integrated into the sensor. The resultant digital signal is communicated to a processor sub-system.

### Processor

The processor subsystem can perform a variety of functions within the handheld device. The first function can be controlling all of the local peripherals—one or more displays, LED light, speaker, microphone, network interface, headphone connection, video capture subsystem, timer, key, flash port, and/or USB or other computer connection. The second function it can perform is to process all of the video, audio and text and adapt it for transmission or process all the received data and adapt it to a form suitable for the local peripherals. Structurally, the above two functions can be implemented as an operating system or run-time executive with drivers for the control of all the peripherals as well as peripheral specific and media specific processing software that performs functions such as compression, protocol translation, and a user interface layer that facilitates communication with the user. In addition, the processor can serve specific functions; both generic and specific to the service that is being provided that are incorporated. The processor sub-system can be implemented at the hardware level as a processor, timer, memory, and I/O controller. The mapping of these functions to actual processor can be dependent on the availability of components and their level of integration. In some embodiments, the processing can be performed on a standard electronic device, such as a mobile telephone, PDA and/or any other know and/or convenient device capable of receiving and processing instructions.

### Display

In some embodiments, the display sub-system can be comprised of a flat-panel screen that can be designed to display text, video and graphics to the user. All of the display data can be generated by the processor or an attached sub-system and converted into electrical signals to drive the display by using drivers. In some embodiments there can be two displays, one for video and graphics and one for text. The two displays could be implemented as a single flat-panel screen driven by two control mechanisms implemented either in the display sub-system or in the processor sub-system. Alternatively, it could be implemented as two independent displays that can be controlled separately. In further embodiments of the device, a touch screen for user input can be included. This could be the chat screen area or the video/graphics area

### Audio

In some embodiments, the audio sub-system can be comprised of a speaker, a microphone and/or a headphone connection. All of these can be driven from the processor sub-system. The speaker and microphone can allow for speakerphone style of communications. In addition, the headphone jack can allow for use in situations where the speakerphone would be disruptive. The quality of audio can be speech quality or better.

### Network Interface

In some embodiments, the network connection can be comprised of a MAC chip, a serializer, wireless transceiver and/or an antenna and/or any other known and/or convenient mechanism. The network interface can provide and receive digital data from the processor sub-system and in turn can transmit and receive signals wirelessly to and from the base station. In further embodiments of the device, secure encrypted communication to the base-station and to the service provider can be implemented.

Instead of communicating with a base-station and then in turn over broadband IP, a variant could communicate to the service provider directly over a cellular network. This is useful in situations where there is no Internet service or when the Internet service and equipment require technical support.

### External Memory Port

In some embodiments, an external memory card port can allow for loading and display of service or self-help instructions.

### PC and/or Device Connectivity

In some embodiments, a USB, IEEE 1394 (Firewire®), wireless (Bluetooth®) and/or any other port/connection known and/or convenient can be used to download service or self-help instructions from a personal computer connected to the Internet and/or any other known and/or convenient source. The connection assumes that the instructions can be downloaded and stored in a memory device that has been plugged into the external memory card port. In some embodiments, the process can be accomplished without any connection to a PC. That is, in some embodiments, the handheld device can receive (via any known and/or convenient data acquisition system and/or method), process and transmit and receive information directly to/from the service provider via a direct (wired and/or wireless) network and/or other data-capable connection. In some embodiments, a mobile telephone can be used to obtain information (video, audio, static image, data-diagnostic or otherwise) and directly transmit the information to the remote service provider. The remote service provider can then directly respond to the user's request via the user's mobile telephone. In alternate embodiments, the system can be implemented on any wired and/or wireless device capable of receiving data and processing instructions.

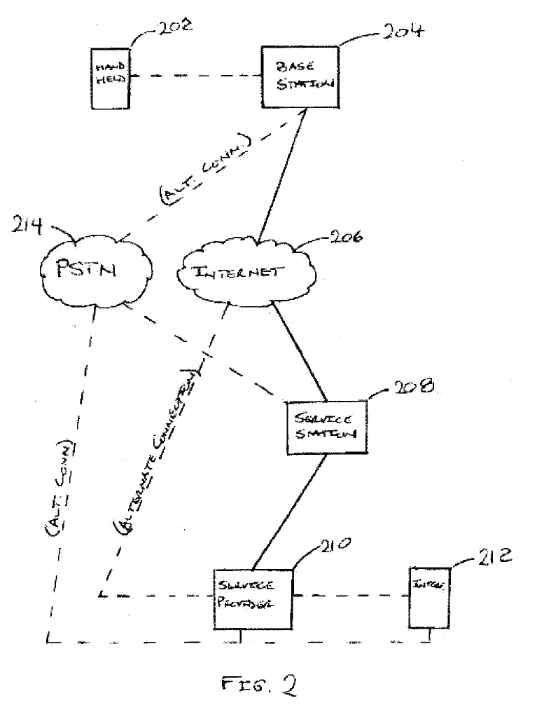

FIG. 2 depicts a block diagram showing the interaction of a handheld device 202, a base station 204, internet connection 206, a service station 208 and a service provider 210 that may interact via an interface 212. In the embodiment shown in FIG. 1, the handheld device 202 can have all, fewer, the same and/or more of the above-described capabilities and can be operated in any one and/or more known and/or convenient manners. In the embodiment shown in FIG. 1, the handheld device can transmit a signal (video, audio, text and/or raw data) to the base station 204. In the embodiment shown in FIG. 2, the signal can be transmitted wirelessly using RF signals. However, in alternate embodiments the signal can be transmitted to the base station in any known and/or convenient manner using any known and/or convenient signal format.

In the embodiment shown in FIG. 2, the base station 204 can have a direct internet connection 206 and can be configured to deliver the received signal to service station 208. Any known and/or convenient connection mechanism and/or protocol can be used to establish and communicate data/information between the base station 204 and the service station 208. In some embodiments, the base station 204 may not be included and the handheld device 202 can connect either directly to or via other known and/or convenient communication mechanisms to the service station 208. By way of non-limiting example, in some embodiments the handheld device 202 can communicate over a “cellular” and/or satellite network with service station 208. In alternate embodiments, any known and/or convenient communication mechanism and/or protocol can be used to establish and communicate data between the base station 204 and the service station 208.

In the embodiment shown in FIG. 2, service station 208 can detect the type of inquiry received from the base station 204 and redirect the inquiry to an appropriate service provider 210 that can handle the inquiry. Redirection of the inquiry can be accomplished via any known and/or convenient mechanism and/or protocol. The service provider 210 can respond directly to the base station 204 and/or the handheld device 202 (depending upon whether the original communication took place via a base station 204). In some embodiments, communications between the service provider 210 and the handheld device can be transmitted via the service station 208, can occur via the base station 204 and/or can be directly between the service provider 210 and the handheld device 202. Additionally, in some embodiments, the service station 208 can handle the inquiry and a service provider 210 may not be needed. In some embodiments, multiple communications between the service provider 210 and the handheld device 202 can be transmitted, such that the user of the handheld device 202 and service provider 210 can interact.

In the embodiment shown in FIG. 2, the service provider has an interface 212 to receive inquiries from one or more handheld devices 202. The service provider can interact with the user of a handheld device via the interface 212. In some embodiments, the interface 212 can be a second handheld device 202 with the all, fewer, the same and/or more of the above-described capabilities. However, in some embodiments, the interface can be any known and/or convenient mechanism which can receive signals transmitted from the handheld device 202 (whether directly or via various communications mechanism and/or protocols) and send signals to the handheld device (whether directly or via various communications mechanism and/or protocols).

In some embodiments, the base station 204 can have an alternate connection to a PSTN 114 and the PSTN can be connected with the service station 208, the service provider 210 and/or the interface 212. In still further alternate embodiments, the handheld device 202, base station 204, service station 208, service provider 210 and interface 212 can be coupled in any convenient manner using any known and/or convenient system and/or mechanism capable of transmission and delivery of a signal.

In further embodiments of the device, the base-station, handheld unit and/or service could include or be supplanted by and/or augmented with any one or more of the following capabilities: Ability to recognize UPC codes using the camera and/or built-in scanner and either local or remote processing allows the service to automatically register the item that requires service; Ability to read and communicate with RFID tags will provide the ability to automatically register the item that requires service; An optional diagnostic interface could be used to communicate with diagnostic ports on any device. The result could be that there is no need to web-enable all of the devices around the consumer or end-user, but to only diagnostic enable them; The service portal could be either a single entity or a pass-through entity with vectoring done either manually by the first level of response, or being selected via the touch-screen from a menu of services that are being provided to the specific consumer. An always-on variant of the device could act as a remote control mechanism for devices that have a diagnostic or control interface connected to the device. In some embodiments the system and method can be implemented over a mobile telephone and/or other portable electronic device capable of making a direct and/or indirect network connection.

In further embodiments of the device, the two-way communication device can be a mobile telephone (hereinafter “cell phones”) with some or all of the above-discussed features and capabilities. In basic embodiments of the device utilizing a cell phone, software downloaded into the cell phone can provide two-way communications with the support service provider utilizing the camera or video camera functions of the cell phone. Some models of cell phones may have video conferencing capabilities that allow for two-way voice and video communication with the support provider. For cell phones without video-streaming capabilities, still photos that update at desired intervals can be used. The users ID can easily be verified using an internal ID of the cell phone unit, the cell phone number (Caller ID), and/or a password. In some embodiments, any number and/or all features of the system and method can be activated by a single user request, such as the touch and/or depression of a single button.

The advantage of using advanced cell phones for the system is that a dedicated hardware device does not have to be used, resulting in monetary savings. The software can be easily downloaded from the cell phones' service providers (possibly for a fee) and can be easily upgraded.

### Overview of Operation of Remote Support Center

A user at a remote location desires to obtain technical support services by using an two-way communication device that communicates over the Internet or the cellular network. The service is provided by personnel at the call-center. The communication can include voice to/from the user, text to the user from the service center, and video from the user location to the service center. This communication can happen over broadband Internet, the cellular network or as over regular analog phone lines. The data rates are adjusted by the device depending on the available communication mechanism. In addition, a non multi-media, voice only call capability that terminates at the service center could be made available.

At the support center, the personnel providing technical support should have access to a terminal, PC or any computing user interface known or convenient that has some or all of the following capabilities and features:

### Identification of the Remote User/Account

A device specific ID is received at the service center that maps to one account can be used for dedicated units. If a cell phone is used as the remote unit, the caller ID or a password can be used to identify the account holder. Optionally information is received that the user has been securely authenticated to the device. When the call is received, all information about the account is immediately available to the service provider by retrieving the pertinent information from a database.

### Multimedia Communication

In order to provide simple to understand instructions and directions to the remote end-user, the terminal or PC at the service provider should have some or all of the following multimedia capabilities.

Text from the service provider can be transmitted to the user using a chat screen; Video transmitted from the user location is displayed to the service provider, and video frames can be reviewed and saved selectively while new video is being displayed; Audio can be bi-directional so that the user can provide details on the problems, and the provider can provide clear instructions for a solution; optionally graphics that is annotated by the technical support personnel to point out areas of interest or other pertinent information can be transmitted to the user; similarly captured video frames can be annotated and transmitted to the user. In further embodiments of the system. voice recognition software can be utilized to convert spoken words into text and transmitted via the chat screen to the user. In some embodiments the system and method can be implemented over a mobile telephone and/or other portable electronic device capable of making a direct and/or indirect network connection.

### Account Management

In preferred embodiments of the system, information about the account can include: Specific configuration details about the registered equipment/items so that information does not have to be captured again from scratch for each new support call; service history logging; service history logging includes knowledge base links for the support personal; diagnostic and service routines that are video enabled can be linked to the service information; Support for pro-active management at programmable service intervals.

### Billing

Account usage information should be linked to billing system so that the time spent on the support call can be directly captured and recorded. The billing system should be capable of tracking by call, by minutes, including remaining minutes if the service plan is purchased in blocks of minutes and the billing system should be capable of billing at different rates based on tier or class of service provided.

### Operational Example

By way of non-limiting example, a user is attempting to connect a new media player device such as a DVD-recorder (DVD-R) to an existing television. The user can use the video capture feature on the handheld device 202 to capture video of the connection panel on the television and the connection panel on the DVD-R. The user can then ad a vocal recording requesting instructions to connect the two devices. The user can then transmit the voice and video signals from the handheld device 202. (In some embodiments, the video and voice date can be captured and simultaneously transmitted to the base station 204 or may be transmitted to the base station without benefit of being captured. In further embodiments, there is no dedicated base station and the hand held device can access the Internet via a wireless hotspot or a router or switch. The signal can be routed via the base station 204 over an internet connection 206 to a service station 208. The service station 208 (either automatically or via human intervention) can determine that a Audio-Visual (A/V) technician would be the appropriate service provider 210 and can route the signal to an available A/V technician service provider 210. The service provider 210 can receive the signals via an interface 212 and review the data. The service provider 210 can then respond to the inquiry in any known and/or convenient manner—text, video, audio and/or any combination thereof.

By way of non-limiting example, the service provider 210 can select individual frames from the video captures received and indicate the appropriate connections on the captured video frames. The service provider 210 can then transmit the response to the handheld device 202. If the user of the handheld device 202 has subsequent questions, the user can continue to interact with the service provider 202 and/or can terminate the inquiry.

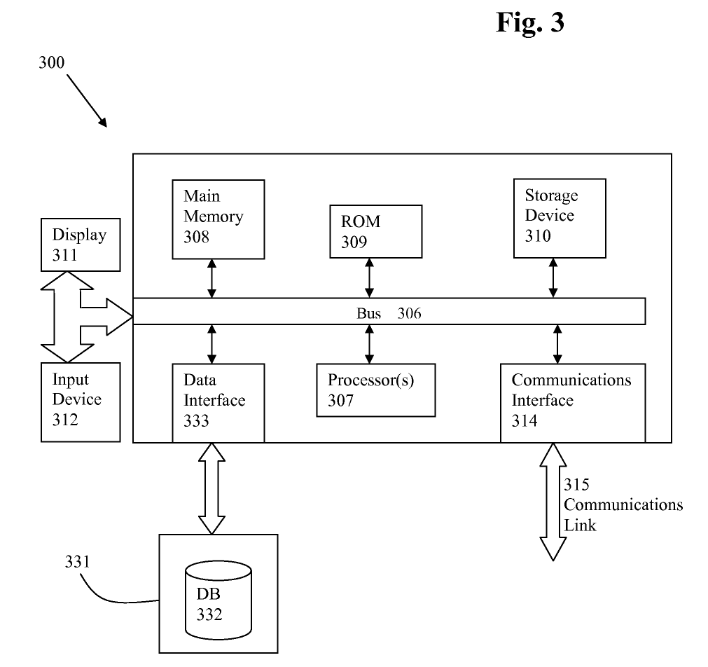

The execution of the sequences of instructions required to practice the embodiments may be performed by a computer system 300 as shown in FIG. 3. In an embodiment, execution of the sequences of instructions is performed by a single computer system 300. According to other embodiments, two or more computer systems 300 coupled by a communication link 315 may perform the sequence of instructions in coordination with one another. Although a description of only one computer system 300 will be presented below, however, it should be understood that any number of computer systems 300 may be employed to practice the embodiments.

A computer system 300 according to an embodiment will now be described with reference to FIG. 3, which is a block diagram of the functional components of a computer system 300. As used herein, the term computer system 300 is broadly used to describe any computing device that can store and independently run one or more programs.

Each computer system 300 may include a communication interface 314 coupled to the bus 306. The communication interface 314 provides two-way communication between computer systems 300. The communication interface 314 of a respective computer system 300 transmits and receives electrical, electromagnetic or optical signals, that include data streams representing various types of signal information, e.g., instructions, messages and data. A communication link 315 links one computer system 300 with another computer system 300. For example, the communication link 315 may be a LAN, in which case the communication interface 314 may be a LAN card, or the communication link 315 may be a PSTN, in which case the communication interface 314 may be an integrated services digital network (ISDN) card or a modem, or the communication link 315 may be the Internet, in which case the communication interface 314 may be a dial-up, cable or wireless modem.

A computer system 300 may transmit and receive messages, data, and instructions, including program, i.e., application, code, through its respective communication link 315 and communication interface 314. Received program code may be executed by the respective processor(s) 307 as it is received, and/or stored in the storage device 310, or other associated non-volatile media, for later execution.

In an embodiment, the computer system 300 operates in conjunction with a data storage system 331, e.g., a data storage system 331 that contains a database 332 that is readily accessible by the computer system 300. The computer system 300 communicates with the data storage system 331 through a data interface 333. A data interface 333, which is coupled to the bus 306, transmits and receives electrical, electromagnetic or optical signals, that include data streams representing various types of signal information, e.g., instructions, messages and data. In embodiments, the functions of the data interface 333 may be performed by the communication interface 314.

Computer system 300 includes a bus 306 or other communication mechanism for communicating instructions, messages and data, collectively, information, and one or more processors 307 coupled with the bus 306 for processing information. Computer system 300 also includes a main memory 308, such as a random access memory (RAM) or other dynamic storage device, coupled to the bus 306 for storing dynamic data and instructions to be executed by the processor(s) 307. The main memory 308 also may be used for storing temporary data, i.e., variables, or other intermediate information during execution of instructions by the processor(s) 307.

The computer system 300 may further include a read only memory (ROM) 309 or other static storage device coupled to the bus 306 for storing static data and instructions for the processor(s) 307. A storage device 310, such as a magnetic disk or optical disk, may also be provided and coupled to the bus 306 for storing data and instructions for the processor(s) 307.

A computer system 300 may be coupled via the bus 306 to a display device 311, such as, but not limited to, a cathode ray tube (CRT), for displaying information to a user. An input device 312, e.g., alphanumeric and other keys, is coupled to the bus 306 for communicating information and command selections to the processor(s) 307.

According to one embodiment, an individual computer system 300 performs specific operations by their respective processor(s) 307 executing one or more sequences of one or more instructions contained in the main memory 308. Such instructions may be read into the main memory 308 from another computer-usable medium, such as the ROM 309 or the storage device 310. Execution of the sequences of instructions contained in the main memory 308 causes the processor(s) 307 to perform the processes described herein. In alternative embodiments, hard-wired circuitry may be used in place of or in combination with software instructions. Thus, embodiments are not limited to any specific combination of hardware circuitry and/or software.

The term “computer-usable medium,” as used herein, refers to any medium that provides information or is usable by the processor(s) 307. Such a medium may take many forms, including, but not limited to, non-volatile, volatile and transmission media. Non-volatile media, i.e., media that can retain information in the absence of power, includes the ROM 309, CD ROM, magnetic tape, and magnetic discs. Volatile media, i.e., media that can not retain information in the absence of power, includes the main memory 308. Transmission media includes coaxial cables, copper wire and fiber optics, including the wires that comprise the bus 306. Transmission media can also take the form of carrier waves; i.e., electromagnetic waves that can be modulated, as in frequency, amplitude or phase, to transmit information signals. Additionally, transmission media can take the form of acoustic or light waves, such as those generated during radio wave and infrared data communications.

In the foregoing specification, the embodiments have been described with reference to specific elements thereof. It will, however, be evident that various modifications and changes may be made thereto without departing from the broader spirit and scope of the embodiments. For example, the reader is to understand that the specific ordering and combination of process actions shown in the process flow diagrams described herein is merely illustrative, and that using different or additional process actions, or a different combination or ordering of process actions can be used to enact the embodiments. The specification and drawings are, accordingly, to be regarded in an illustrative rather than restrictive sense.

It should also be noted that the present invention may be implemented in a variety of computer systems. The various techniques described herein may be implemented in hardware or software, or a combination of both. Preferably, the techniques are implemented in computer programs executing on programmable computers that each include a processor, a storage medium readable by the processor (including volatile and non-volatile memory and/or storage elements), at least one input device, and at least one output device.

Program code is applied to data entered using the input device to perform the functions described above and to generate output information. The output information is applied to one or more output devices. Each program is preferably implemented in a high level procedural or object oriented programming language to communicate with a computer system. However, the programs can be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The system may also be considered to be implemented as a computer-readable storage medium, configured with a computer program, where the storage medium so configured causes a computer to operate in a specific and predefined manner. Further, the storage elements of the exemplary computing applications may be relational or sequential (flat file) type computing databases that are capable of storing data in various combinations and configurations.

Although exemplary embodiments of the invention has been described in detail above, those skilled in the art will readily appreciate that many additional modifications are possible in the exemplary embodiments without materially departing from the novel teachings and advantages of the invention. Accordingly, these and all such modifications are intended to be included within the scope of this invention construed in breadth and scope in accordance with the appended claims.

What is claimed is:

1. A system for remote provision of support services comprising:
a handheld unit, said handheld unit comprising a display screen, an image capture device capable of capturing digital images,
a microphone for recording of analog voice signals, an A/D converter for converting said analog voice signals into digital signals and digital signals into voice signals, a sound emission device to play back analog voice signals,
a wireless transceiver for wireless communication with an network;
a microprocessor for processing said digital images and digital voice data,
a button that activates the handheld unit to begin bi-directional communication over the network to a remote location;
wherein the user with the handheld unit can use the handheld unit to record and send information of areas of interest and send it in real-time to a remote location over the network, and
technical support personnel located at the remote location can provide technical support services to the user with the handheld unit based on the information sent by said user, and relay instructions to the user via the network.

2. The system of claim 1, wherein said network is the Internet.

3. The system of claim 1, wherein said network is wireless.

4. The system of claim 1, wherein said bi-directional communication comprises voice and video.

5. The system of claim 1, wherein said bi-directional communication comprises voice and still images.

6. The system of claim 1, wherein said bi-directional communication comprises text and still images.

7. The system of claim 1, wherein said instructions is provided via spoken instructions and images displayed on the display screen.

8. The system of claim 1, wherein said instructions is provided via spoken instructions and video displayed on the display screen.

9. The system of claim 1, wherein said handheld unit has a unique identification that allows the technical support personnel located at the remote location to identify the user and access a database that stores information on the user's equipment configuration.

10. The system of claim 1, wherein said handheld unit is a cellular telephone.

11. The system of claim 1, wherein the handheld unit further comprises illumination means to illuminate areas of interest for capturing digital images with the image capture device in low-light situations.

12. The system of claim 1, further comprising a base unit to which the handheld unit can be docked with, said handheld unit capable of communicating wirelessly with the base unit when the handheld unit is removed from the base unit, and said base unit being connected to a network.

13. The system of claim 1, wherein the handheld unit further comprises a tripod.

14. The system of claim 1, wherein the handheld unit further comprises a memory card reader.

15. The system of claim 10, wherein software for handling bi-directional communication with the remote support center can be downloaded to the cellular phone.

16. The system of claim 1, wherein the image capture device can be swiveled so that it points towards the display screen for two-way voice communication face-to-face, and point away from the view screen to capture areas of interest while the end-user views what is being captured on the screen.

17. A system for remote provision of support services comprising:
a handheld device adapted to obtain at least one of diagnostic data, video images, still images and audio;
a wireless transceiver for wireless communication with an network coupled with said handheld device; and
a microprocessor for processing at least one of said diagnostic data, said video images, said still images and said audio,
wherein the handheld device selectively transmits at least one of said diagnostic data, said video images, said still images and said audio, and
wherein technical support information is transmitted to the handheld device in response to the transmitted at least one of said diagnostic data, said video images, said still images and said audio.
